(19) United States
(12) Patent Application Publication
(10) Pub. No.: US 2011/0239027 A1
(43) Pub. Date: Sep. 29, 2011

(54) COMMON APPARATUS POWER CONTROL SYSTEM, COMMON APPARATUS AND METHOD FOR CONTROLLING POWER OF COMMON APPARATUS

(75) Inventors: Hiroki Sugiyama, Osaka (JP); Seiichi Yoshida, Osaka (JP)

(73) Assignee: Sharp Kabushiki Kaisha, Osaka (JP)

(21) Appl. No.: 13/052,630

(22) Filed: Mar. 21, 2011

(30) Foreign Application Priority Data
Mar. 23, 2010 (JP) 2010-066838

(51) Int. Cl. G06F 1/28

(52) U.S. Cl. 713/340

(57) ABSTRACT

To provide a common apparatus power control system including: a multiple number of client apparatuses; a server apparatus; and a common apparatus connected to the multiple client apparatuses and the server apparatus via a network. The common apparatus performs communication with the server apparatus and acquires information on whether the power sources to all the client apparatuses on the network have been shut off, from the server. The common apparatus includes a power controller that controls the power mode of the common apparatus when the power to all the client apparatuses has been shut off.

This Nonprovisional application claims priority under 35 U.S.C. §119 (a) on Patent Application No. 2010-066838 filed in Japan on 23 Mar. 2010, the entire contents of which are hereby incorporated by reference.

### BACKGROUND OF THE INVENTION

(1) Field of the Invention

The present invention relates to a common apparatus power control system and the like, including a plurality of client apparatuses, a server apparatus and a common apparatus connected to the plural client apparatuses and server via a network.

(2) Description of the Prior Art

Conventionally, in an office or the like where a plurality of client apparatuses and common apparatuses (e.g., common printers, common hard disk drives, common MO devices, etc.) are installed and connected via a network (e.g., an LAN formed by Ethernet (trade name)), it is usual that the plural client apparatuses share common apparatuses via the network in order to reduce the number of common apparatuses and in order to efficiently use these common apparatuses.

Under such circumstances, there occurs the problem of how to control the power sources to the common apparatuses.

As a conventional example relating to power control of a common apparatus, there is a disclosure of a technology in a Patent Document 1, for example.

Patent Document 1 discloses an automatic power shut-off mechanism which automatically shuts off a common apparatus by periodically checking whether the power to all the client apparatuses that share the common apparatus via a LAN is shut down by using PING (Packet Internet Groper) responses and determining that all the client apparatuses have been shut down when no PING response from any of the client apparatuses is detected.

### Patent Document 1:

Japanese Patent Application Laid-open 2000-293272.

However, in the above conventional configuration, it is necessary for the common apparatus to periodically transmit a PING command to all the client apparatuses on the network, posing a problem that the network traffic is constantly increased. In particular, and notwithstanding, that all of the client apparatuses are rarely shut down in the daytime, PING commands load the network constantly, resulting in a problem that network resources are continuously consumed.

### SUMMARY OF THE INVENTION

The present invention has been devised in view of the above problems, it is therefore an object of the present invention to provide a common apparatus power control system or the like that can reduce the standby power consumption of a common apparatus while minimizing the influence on the network traffic without the need of complicated control and without the need of making any modifications to the client apparatuses connected via the network.

To achieve the above object, the common apparatus power control system of the present invention includes:

a plurality of client apparatuses;

a server apparatus; and,

a common apparatus connected to the plural client apparatuses and the server apparatus via a network, characterized in that

the common apparatus includes:

a communicator for performing communication with each of the client apparatuses and the server;

an acquisitor for acquiring information on whether the power sources to all the client apparatuses on the network have been shut off, from the server via the communicator; and,

a power controller that controls the power mode of the common apparatus when the acquisitor obtains the information that the power to every client apparatus is shut off.

The common apparatus power control system is further characterized in that the power controller, based on the configuration of the common apparatus, determines whether the power to each functional component of the common apparatus should be shut off or should be sustained.

Also, the common apparatus power control system is characterized in that the server apparatus includes a storage that stores ID information, IP address, release information of the IP address, for each of the client apparatuses, and provides the IP address release information stored in the storage to the common apparatus, in response to the request from the acquisitor of the common apparatus.

The common apparatus of the present invention, connected to a plurality of client apparatuses and a server apparatus via a network, includes:

a communicator for performing communication with each client apparatus and the server;

an acquisitor for acquiring information on whether the power sources to all the client apparatuses on the network have been shut off, from the server via the communicator; and,

a power controller that controls the power status of the common apparatus when the acquisitor obtains the information that the power to all the client apparatuses is shut off.

According to the present invention, a method for controlling power of a common apparatus connected to a plurality of client apparatuses and a server apparatus, is characterized in that the method includes:

a communication step in which the common apparatus communicates with each client apparatus and the server apparatus;

an acquisition step in which the common apparatus acquires information on whether the power sources to all the client apparatuses on the network have been shut off, from the server through the communication step; and,

a power control step in which the common apparatus is controlled into a power-saving mode when the information representing that the power to all the client apparatuses has been shut off is obtained through the acquisition step.

In the common apparatus power control system of the present invention, control is performed such that when the power sources to all the client apparatuses that shares a common apparatus on the network are shut off, the power to the common apparatus is automatically shut down.

The common apparatus periodically acquires the information that represents whether the power sources to all the client apparatuses on the network have been shut off, from the server apparatus.

The server apparatus is provided with a DHCP server function so that it is possible to obtain the information on whether the power sources to all the client apparatuses on the network have been shut off, based on the IP address release information the server apparatus handles.

The above configuration makes it possible to shut down the power to the common apparatus the moment the power sources to all the client apparatuses on the network have been turned off, hence cut off the standby power consumption. Accordingly, it is possible to economically achieve cut down the standby mode power consumption of the above-described common apparatus without the need of performing complicated control and without the need of making any modifications to the client apparatuses connected on the network.

### BRIEF DESCRIPTION OF THE DRAWINGS

FIG. 1 is a diagram for illustrating the whole of a common power system of the present embodiment;

FIG. 2 is a block diagram for illustrating the functional configuration of a common apparatus in the present embodiment;

FIG. 3 is a block diagram for illustrating the functional configuration of a server apparatus in the present embodiment;

FIG. 4 is a diagram showing one data configuration example of a management list in the present embodiment;

FIG. 5 is a block diagram for illustrating the functional configuration of a client apparatus in the present embodiment;

FIG. 6 is a flow chart for illustrating the process of a common apparatus in the present embodiment;

FIG. 7 is a flow chart for illustrating the process of a client apparatus in the present embodiment; and,

FIG. 8 is a flow chart for illustrating the process of a server apparatus in the present embodiment.

### DESCRIPTION OF THE PREFERRED EMBODIMENTS

The best mode for carrying out the present invention will hereinafter be described with reference to the accompanying drawings. Here, the present embodiment will be described by taking an example of a common power control system in which digital multifunctional machines having image forming functionality are connected as the common apparatuses. Next, the embodiment of the present invention will be described in detail with reference to the drawings.

### 1. System Configuration

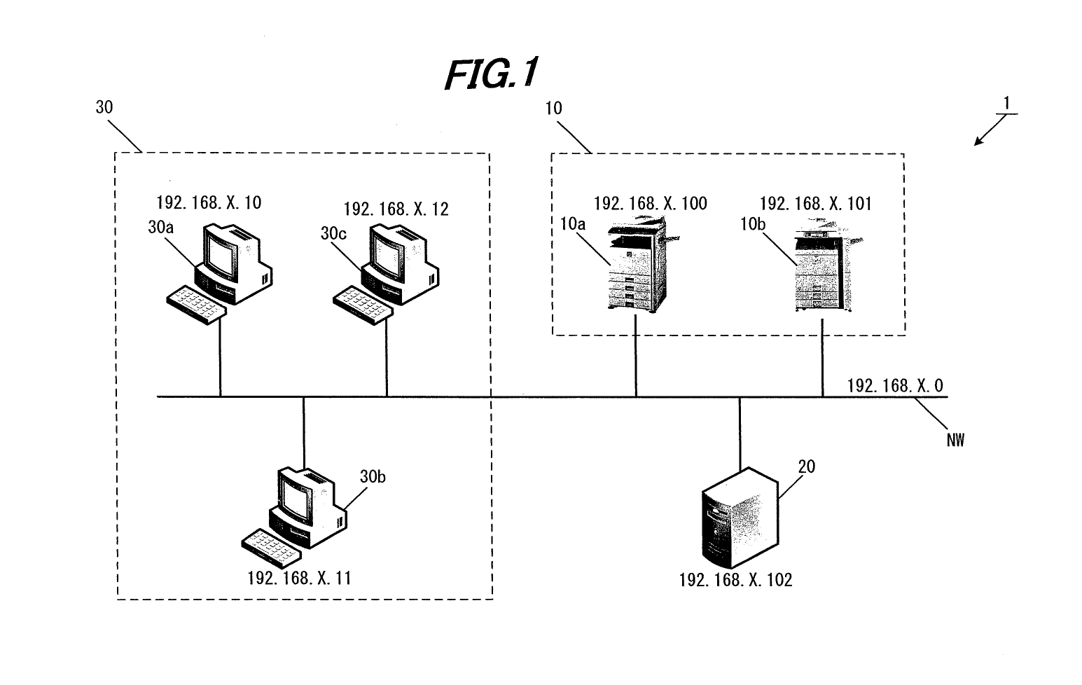

A common apparatus power control system 1 to which the present invention is applied will be described with FIG. 1.

Common apparatus power control system 1 is configured of common apparatuses 10 (10a, 10b), a server apparatus 20, client apparatuses 30 (30a, 30b and 30c), all being connected via a network NW (LAN (Local Area Network)).

Here, the network IP address of network NW is “192.168.X.0”, server apparatus 20 has the function of a DHCP (Dynamic Host Configuration Protocol) server. That is, server apparatus 20 dynamically manages the IP (Internet Protocol) addresses of multiple client apparatuses 30 connected to network NW.

Common apparatuses 10 (10a, 10b) are the apparatuses shared by multiple client apparatuses 30, which in the present embodiment, are given as digital multifunctional machines having image forming functions such as a printer function, facsimile function, copying function and the like. Here, it is usual that common apparatuses 10 are operated using fixed IP addresses. In the present embodiment, common apparatus 10a is assigned with a fixed IP address of “192.168.X.100”, and common apparatus 10b with “192.168.X.101”.

Client apparatuses 30 (30a, 30b, 30c) are terminals operated by users, which, for example, are personal computers (PC) and the like. It is assumed that each client apparatus 30 is assigned with a dynamic IP address by the DHCP function of server apparatus 20. In FIG. 1, client apparatus 30a is assigned with “192.168.X.10”, client apparatus 30b with “192.168.X.11” and client apparatus 30c with “192.168.X.12”.

Though in the present embodiment, a wired LAN is used for connection, it goes without saying that client apparatuses 30 can be connected by a wireless LAN such as IEEE802.11b, for example.

### 2. Apparatus Configurations

The configuration of each apparatus connected to common apparatus power control system 1 will be described with reference to the drawings.

### 2.1 Common Apparatus

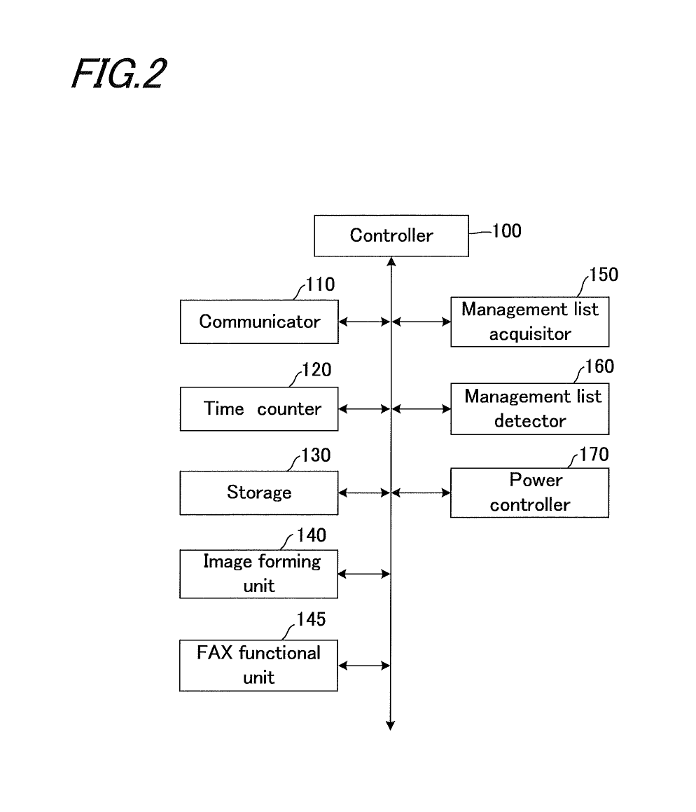

The functional configuration of common apparatus 10 will be described with reference to FIG. 2.

FIG. 2 is a functional block diagram of common apparatus 10.

Common apparatus 10 includes a controller 100 to which a communicator 110, a time counter 120, a storage 130, an image forming unit 140, a FAX functional unit 145, a management list acquisitor 150, a management list detector 160 and a power controller 170 are connected via a bus.

Controller 100 includes: a functional unit for controlling common apparatus 10 and is configured of a CPU or the like, for instance. Controller 100 loads a program recorded (stored) in storage 130 and executes the program to realize the process based on the program.

Communicator 110 is a functional unit for performing communication with apparatuses via network NW. This communicator is composed of a NIC (Network Interface Card) or the like conforming to the Ethernet (trade name) standard. Specifically, the communicator performs communication using packets conforming to TCP/IP (Transmission Control Protocol/Internet Protocol). In the present embodiment, for example, packets etc. used for assigning IP addresses by DHCP (Dynamic Host Configuration Protocol) are exchanged.

Time counter 120 is a function unit having a clocking function and performs counting for transmitting packets at regular intervals of a fixed time.

Storage 130 stores the programs and various kinds of data, etc., necessary for operating common apparatus 10. Storage 130 may be configured of, for example, a semiconductor memory device such as DRAM, EEPROM, a magnetic disk device such as a hard disk drive and/or some other storage device.

Image forming unit 140 is a functional unit necessary for common apparatus 10 to operate as a digital multifunctional machine (image forming apparatus). Image forming unit 140 forms images on recording paper in accordance with printing data received from each client apparatus 30 by way of communicator 110, for example, or forms images on recording paper in accordance with image data scanned by an image reader included in image forming unit 140.

FAX functional unit 145 is a functional unit necessary for common apparatus 10 to operate as a facsimile machine. For example, FAX functional unit 145 is connected to an ISDN (Integrated Services Digital Network) line and outputs image data received via the ISDN line to image forming unit 140.

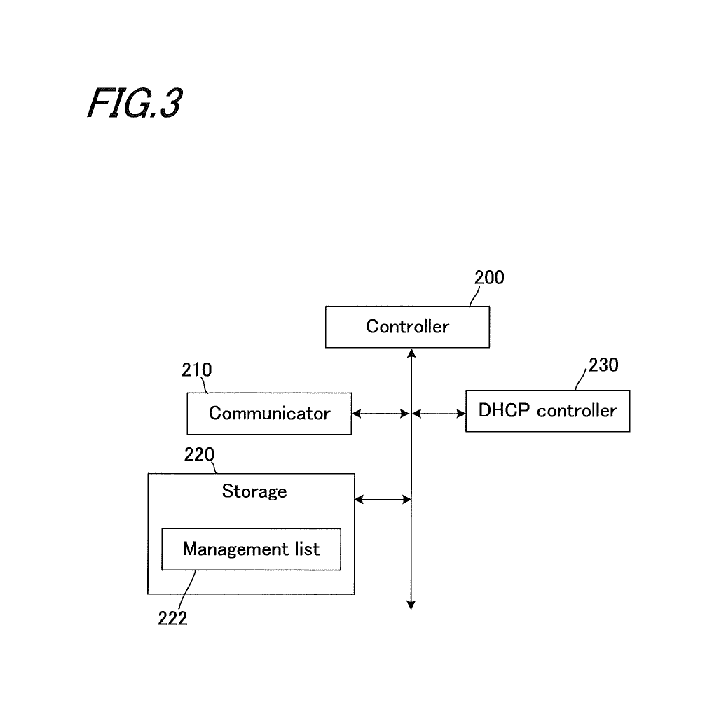

Management list acquisitor 150 is a functional unit that requests acquisition of a management list 222 (FIG. 3) from server apparatus 20 that manages IP address release information held by server apparatus 20.

Management list detector 160 is a functional unit that performs an AND operation (logical product) on all the IP address releases statuses in management list 222 obtained from server apparatus 30 to detect whether all the release statuses are “X”. Then, when all the IP address release statuses are found to be “X”, management list detector 160 sends a power shut-off request to power controller 170.

Power controller 170 is a functional unit for shutting off the power of common apparatus 10 in response to the power shut-off request from management list detector 160. Here, if common apparatus 10 includes an option that has to be constantly activated (FAX functional unit 145 in the present embodiment), the power controller 170, when receiving a power shut-off request message from management list detector 160, turns off the power except the option to be constantly activated.

### 2.2 Server Apparatus

The functional configuration of server apparatus 20 will be described with reference to FIG. 3.

FIG. 3 is a functional block diagram of server apparatus 20.

Server apparatus 20 is connected to a controller 200 via a bus to which a communicator 210, a storage 220, a DHCP controller 230 are connected.

Controller 200 is a functional unit for controlling server apparatus 20 and configured of a CPU and the like, for example. Controller 200 loads a program recorded in storage 220 and executes the program to realize the process based on the program.

Communicator 210 is a functional unit for communicating with other apparatuses via network NW. Since communicator 210 has the same functionality as that of communicator 110 of common apparatus 10, the detailed description is omitted.

DHCP controller 230 manages assignment, release, etc. of an IP address, based on the protocol defined by DHCP (Dynamic Host Configuration Protocol), in response to an IP address request from client apparatus 30. Though the present embodiment will be described taking an example using IPv4 (Internet Protocol Version 4) as the communication protocol, the IP address may be assigned using IPv6 (Internet Protocol Version 6).

DHCP is a protocol for automatically assigning necessary information such as an IP address etc., to a client apparatus 30 that temporarily connects to network NW. Use of DHCP server functionality enables prompt connection with a suitable setting without the need of any manual network setting so as to allow a user who is not familiar to network setting to establish connection easily. Further, DHCP server functionality makes it possible for the network administrator to easily perform unified management of many client apparatuses 30.

DHCP controller 230 manages information necessary for connection to network NW using the aftermentioned management list 222 and provides the information to a client apparatus 30 that begins to connect to the network. When a client apparatus 30 that has been connected to the network disconnects communication, DHCP controller 230 automatically collects the IP address and the like and assigns the IP address to another client apparatus 30 that begins to connect.

Storage 220 is a functional unit for storing the programs and various kinds of data, etc., necessary for operating server apparatus 20. Storage 220 may be configured of, for example, a semiconductor memory device such as DRAM, EEPROM, a magnetic disk device such as a hard disk drive and/or some other storage device.

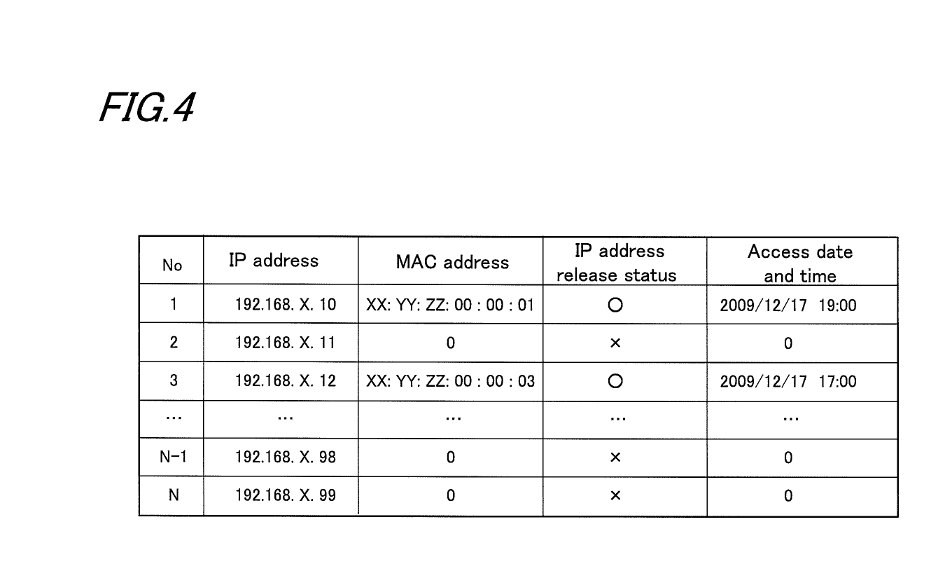

Storage 220 stores management list 222 that manages assignment and release of IP addresses for client apparatuses 30. Now, one data configuration example of management list 222 will be described with reference to FIG. 4.

As shown in FIG. 4, management list 222 includes: a term number (e.g., “1”) of a client apparatus 30; an IP address field holding an IP address (e.g., “192.168.x.10”) assigned to the client apparatus 30 by DHCP functionality; a MAC address field holding a MAC (Media Access Control) address (e.g., “XX:YY:ZZ;00:00:01”) of the client apparatus 30; an IP address release status field representing the release status (release information) (e.g., “◯”) of the IP address; and an access date and time field holding the access date and time (e.g., “2009/12/17 19:00”) of client apparatus 30.

Here, “◯ (the IP address is being assigned)” is stored in the IP address release status field of an IP address to which a client apparatus 30 is assigned, whereas “X (the IP address is being released)” is stored in the IP address release status field of an IP address to which no client apparatus 30 is assigned.

When a client apparatus 30 is activated, server apparatus 20, following the DHCP server functionality, assigns an IP address which is being released (“X”) in the management list 222 to the client apparatus 30. Further, server apparatus 20 stores the MAC address of the client apparatus 30, “◯” and the access date and time, into the MAC address field, IP address release status field and access date and time field of the term number in management list 222, respectively.

Thereafter, when the power of the client apparatus 30 is turned off, server apparatus 20 releases the corresponding IP address, following the DHCP server functionality. At this point, the release status field of the corresponding IP address in management list 222 is stored with “X” while the contents in the MAC address field and access date and time field of the IP address are deleted or stored with “0”.

Further, it is assumed that the MAC address field and access date and time field of an unused term number are stored with “0” and that even if all of the IP addresses are not released within the same date, the IP address release status fields on management list 222 are temporarily input with “X” and regarded as being unused. It is also assumed that when a new client apparatus 30 begins to connect to server apparatus 20 via network NW, the client apparatus is assigned with an IP address having the lowest unused term number.

Server apparatus 20 having the DHCP server function enables the release information of IP addresses the server apparatus 20 manages, to be stored into management list 222 and updated therein.

### 2.3 Client Apparatus

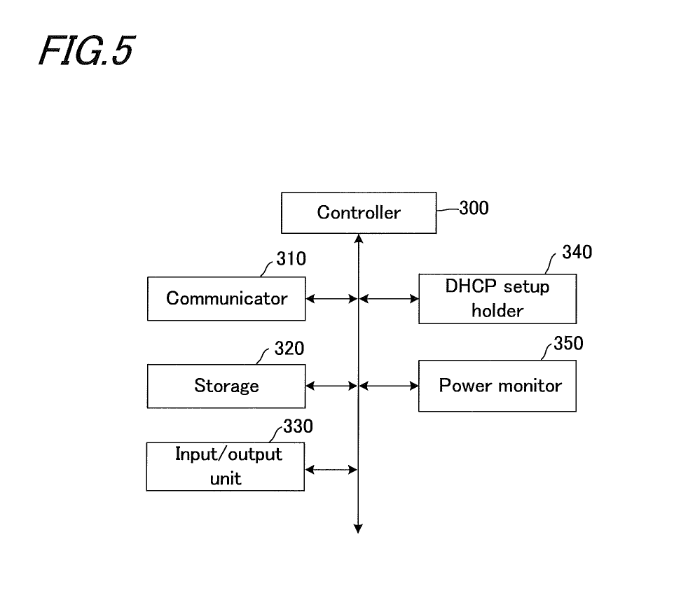

The functional configuration of client apparatus 30 will be described with reference to FIG. 5.

FIG. 5 is a functional block diagram of client apparatus 30.

Client apparatus 30 is connected to a controller 300 via a bus to which a communicator 310, a storage 320, an input/output unit 330, a DHCP setup holder 340 and a power monitor 350 are connected.

Controller 300 is a functional unit for controlling client apparatus 30 and configured of a CPU and the like, for example. Controller 300 loads a program recorded in storage 320 and executes the program to realize the process based on the program.

Communicator 310 is a functional unit for communicating with other apparatuses via network NW. This communicator is configured of a NIC conforming to the Ethernet (trade name) standard, for example. Specifically, communicator 310 performs communication by packets conforming to TCP/IP (Transmission Control Protocol/Internet Protocol). In the present embodiment, packets etc. used for assigning IP addresses by DHCP (Dynamic Host Configuration Protocol) are exchanged.

Storage 320 is a functional unit for storing the programs and various kinds of data, etc., necessary for operating client apparatus 30. Storage 320 may be configured of, for example, a semiconductor memory device such as DRAM, EEPROM, a magnetic disk device such as a hard disk drive and/or some other storage device.

Input/output unit 330 is a functional unit to be used when the user operates client apparatus 30. The user gives various operational instructions to client apparatus 30 through the input portion of input/output unit 330 and confirms the result of processing from the output portion of input/output unit 330. The input portion is configured of, for example a keyboard, a mouse and a touch panel, etc. and the output portion is configured of a display device such as an LCD.

DHCP setup holder 340 is a functional unit is a functional unit that holds DHCP settings (IP address, subnet mask, release duration, etc.) obtained from server apparatus 20.

Power monitor 350 is a functional unit that is monitoring the power status of client apparatus 30. Power monitor 350 monitors the power status of client apparatus 30 and notifies DHCP setup holder 340 of shutting off the power when the power is turned off.

### 3. Processing Flow

The flow of processing of each apparatus in the present embodiment will be described using flow charts.

### 3.1 Common Apparatus

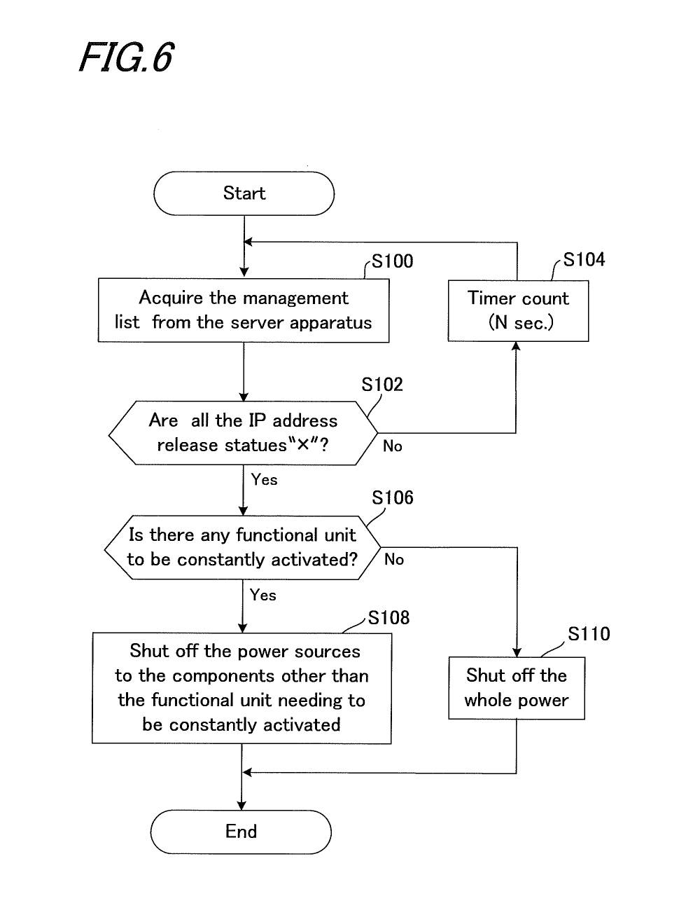

The process at common apparatus 10 will be described with FIG. 6.

FIG. 6 is a flow chart of a case where common apparatus 10 acquires management list 222 from server apparatus 20 to perform power control.

To begin with, the common apparatus acquires management list 222 from server apparatus 20 (Step S100). At this point, it is determined whether all the IP address release status fields of management list 222 are “X” (Step S102). If all of the IP address release status fields are not “X”, or if at least one of them is “◯” (Step S102; No), timer counting of predetermined seconds (N sec.) is performed (Step S104), and the control returns to Step S100.

Here, at Step S102, when all of the IP address release status fields are determined to be “X” (Step S102; Yes), it is determined whether common apparatus 10 includes a functional unit with its power constantly turned on (for example, an optional unit etc. needing to be constantly activated) (Step S106). Here, when there is a functional unit needing to be constantly turned on (Step S106; Yes), the power to the other functional units than the functional unit needing to be constantly turned on is shut off (Step S106; Yes→Step S108).

On the other hand, when there is no functional unit needing to be constantly turned on (Step S106; No), all the power to common apparatus 10 is shut off (Step S110).

### 3.2 Client Apparatus

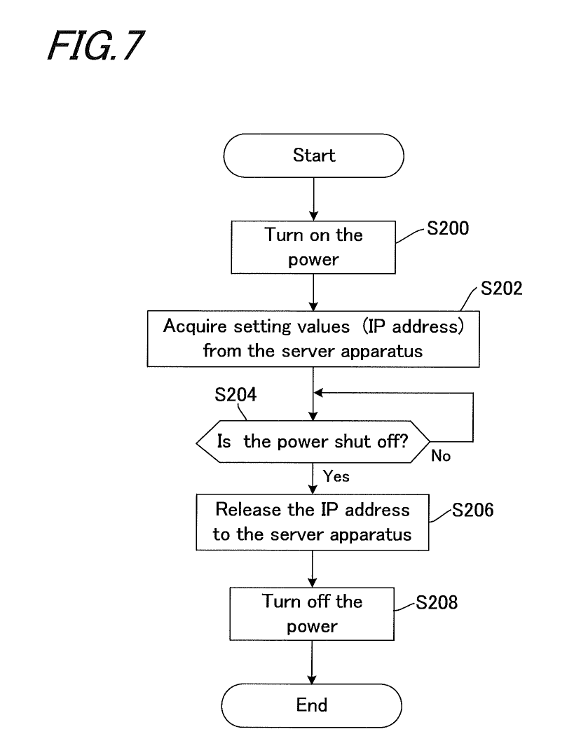

The process in client apparatus 30 will be described with reference to FIG. 7.

FIG. 7 is a flow chart for illustrating IP address acquisition/release by the DHCP function in client apparatus 30.

First, the power to client apparatus 30 is turned on (Step S200). Client apparatus 30 acquires an IP address and other setting values form server apparatus 20 (Step S202). Then, client apparatus 30 stands by until the power is turned off (Step S204; No).

Here, when client apparatus 30 detects that its power is going to be turned off (Step S204; Yes), the client apparatus 30 releases the current IP address to server apparatus 20 (Step S206), and then executes a power shut-off operation (turning off the power) (Step S208).

### 3.3 Server Apparatus

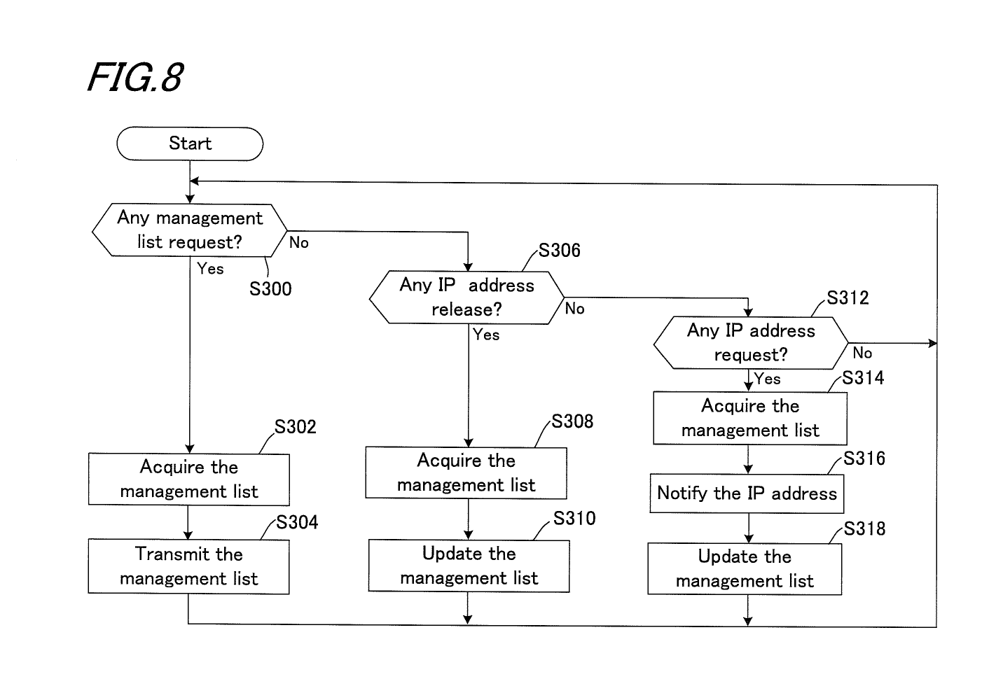

The process at server apparatus 20 will be described using FIG. 8.

FIG. 8 is a flow chart relating to IP address notice/release by DHCP in server apparatus 20 and response to a management list acquisition request.

Server apparatus 20 first determines whether there is a request for the management list from common apparatus 10 (Step S300). When the management list is requested (Step S300; Yes), server apparatus 20 acquires management list 222 stored in storage 220 (Step S302), transmits management list 222 to the requesting common apparatus 10 (Step S304), and goes back to Step S300.

Subsequently, when there is no request for management list 222 (Step S300; No), server apparatus 20 determines whether there is an IP address release from client apparatus 30 (Step S306).

At this Step, if there is an IP address release (Step S306; Yes), server apparatus 20 acquires management list 222 stored in storage 220 (Step S308) and updates management list 222 (Step S310). Specifically, “MAC address” and “access date and time” of the term number of the released IP address are deleted (i.e., input with “0”) and the IP address release status field is input with “X”. Then, the server apparatus 20 brings back its control to Step S300 and repeats the same process.

On one hand, when there is no IP address release (Step S306; No), server apparatus 20 determines whether there is any IP address request from client apparatus 30 (Step S312). If there is no IP address request (Step S312; No), server apparatus 20 repeats the same process from Step S300.

On the other hand, if there is an IP address request from client apparatus 30 (Step S312; Yes), server apparatus 20 acquires management list 222 stored in storage 220 (Step S314) and assigns and notifies an unused IP address in management list 222 to the IP-address requesting client apparatus 30 (Step S316). Further, the “MAC address”, “◯” and “access date and time” are recorded into the term number of the IP address that was assigned in management list 222 at Step S316 to thereby update management list 222 (Step S318). Then, server apparatus 20 returns its control to Step S300 and repeats the same process from Step S300.

As have been described heretofore, according to the present invention, it is possible to determine that the power to all the client apparatuses 30 that share common apparatus 10 on network NW is shut off, based on management list 222. Since the power to common apparatus 10 is shut down automatically when the power sources to client apparatuses 30 have been all shut off, it is possible to expect power saving effect. Further, it is possible to economically achieve the expected results in the power management of client apparatuses without the need of performing complicated control and without the need of making any modifications to the client apparatuses connected on the network.

### 4. Variational Example

Though the invention was described in detail taking an example of an embodiment with reference to the drawings, the specific configuration should not limited to this embodiment. It is apparent that variational designs and modifications that will not depart from the spirit or scope of the invention should be included within the scope of the following claims.

Further, though in the above embodiment, a digital multifunctional machine was taken as an example of a common apparatus, it goes without saying that the invention can be applied even if the common apparatuses are other equipment including hard disk drives (NAS), printers, computers such as file servers.

What is claimed is:

1. A common apparatus power control system comprising:
a plurality of client apparatuses;
a server apparatus; and,
a common apparatus connected to the plural client apparatuses and the server apparatus via a network, characterized in that
the common apparatus includes:
a communicator for performing communication with each of the client apparatuses and the server;
an acquisitor for acquiring information on whether the power sources to all the client apparatuses on the network have been shut off, from the server via the communicator; and,
a power controller that controls the power mode of the common apparatus when the acquisitor obtains the information that the power to every client apparatus is shut off.

2. The common apparatus power control system according to claim 1, wherein the power controller, based on the configuration of the common apparatus, determines whether the power to each functional component of the common apparatus should be shut off or should be sustained.

3. The common apparatus power control system according to claim 1, wherein the server apparatus includes a storage that stores ID information, IP address, release information of the IP address, for each of the client apparatuses, and provides the IP address release information stored in the storage to the common apparatus, in response to the request from the acquisitor of the common apparatus.

4. A common apparatus connected to a plurality of client apparatuses and a server apparatus via a network, comprising:
a communicator for performing communication with each client apparatus and the server;
an acquisitor for acquiring information on whether the power sources to all the client apparatuses on the network have been shut off, from the server via the communicator; and,
a power controller that controls the power status of the common apparatus when the acquisitor obtains the information that the power to all the client apparatuses is shut off.

5. A method for controlling power of a common apparatus connected to a plurality of client apparatuses and a server apparatus, characterized in that the method includes:
a communication step in which the common apparatus communicates with each client apparatus and the server apparatus;
an acquisition step in which the common apparatus communicates information on whether the power sources to all the client apparatuses on the network have been shut off, from the server through the communication step; and,
a power control step in which the common apparatus is controlled into a power-saving mode when the information representing that the power to all the client apparatuses has been shut off is obtained through the acquisition step.
